(19) United States
(12) Patent Application Publication
(10) Pub. No.: US 2012/0300032 A1
(43) Pub. Date: Nov. 29, 2012

(54) ENDOSCOPE

(75) Inventor: Minoru Ookoba, Sagamihara-shi (JP)

(73) Assignee: CANON KABUSHIKI KAISHA, Tokyo (JP)

(21) Appl. No.: 13/477,939

(22) Filed: May 22, 2012

(30) Foreign Application Priority Data
May 25, 2011 (JP) 2011-117136

(51) Int. Cl. H04N 13/04

(52) U.S. Cl. 348/45; 348/E13.074

(57) ABSTRACT

An endoscope includes a treatment tool, a right eye image capturing unit, and a left eye image capturing unit. The right eye image capturing unit and the left eye image capturing unit capture images which are to be displayed as a stereoscopic image of an image capturing target. The maximum convergence angle of arbitrary point in movable range of the treatment tool which exists in both visual fields of the right eye image capturing unit and the left eye image capturing unit is 30 degrees or less.

### BACKGROUND OF THE INVENTION

1. Field of the Invention

The present invention relates to an endoscope in which images that may be displayed as a stereoscopic image is captured.

2. Description of the Related Art

A stereoscopic endoscope is capable of capturing a plurality of parallax images (images obtained from slightly different angles) and fusing the captured images to create stereoscopic (three-dimensional) display of an image. Herein, the term “parallax” indicates the angle or semi-angle between two lines-of-sight from an imaging device to an object.

A treatment tool capable of administering medication to an affected area is inserted in a main body of an endoscope together with an optical system for observation. An endoscope with this configuration requires only one invasive location in the human body and enables observation and treatment with a small incision area.

FIG. 7 is a plane view of a tip of a stereoscopic endoscope described in Japanese Patent Application Laid-Open No. 2008-136671. As illustrated in FIG. 7, an endoscope tip 19 is provided with a left objective lens 2L, a right objective lens 2R, an illumination window 4, and a port 13 of a treatment tool insertion channel. The right objective lens 2R is an image capturing lens corresponding to an image of the right eye and the left objective lens 2L is an image capturing lens corresponding to an image of the left eye.

As illustrated in FIG. 8A, when an endoscope is in use, a treatment tool 6, such as a laser probe, projects from a port formed at a tip 19 of the endoscope. An area which may be observed through the objective lenses 2R and 2L is located inside the boundary line of the visual fields 8. Thus, observation with the treatment tool 6 is impossible unless the treatment tool 6 extends to reach this visual fields 8. A state illustrated in FIG. 8A is observed through the objective lenses 2R and 2L as illustrated in FIG. 8B. A state in which an image captured through the objective lenses 2R and 2L is displayed on a display device 10 as a stereoscopic display image is illustrated in FIG. 8C. The image displayed on the display device 10 is observed by a viewer 11 as a treatment tool image as if the treatment tool is located at a position denoted by reference numeral 26.

The stereoscopic image projected by the stereoscopic endoscope allows the viewer to carry out accurate treatment. Stereoscopic projection is achieved on the basis of at least two parallax images of the object.

A convergence angle 7 between two crossing line segments, one of which extends between a base of the treatment tool 6, which is located inside the observable area and near the port, and an image capturing center of the right object lens, and the other of which extends between the base of the treatment tool 6 and an image capturing center of the left object lens, is larger than a convergence angle 7′ between two crossing line segments, one of which extends between the tip of the treatment tool 6 and the image capturing center of the right object lens, and the other of which extends between the tip of the treatment tool 6 and the image capturing center of the left object lens.

Accordingly, it is difficult for the viewer to focus (i.e., fuse) the right and left eye visions at the base of the treatment tool at which the convergence angle is large and, therefore, to view the image as a stereoscopic image. In this configuration, the base of the treatment tool is a disturbance factor to the user. Fusion of images herein is a process to visually fuse a plurality of parallax images into a single image.

If the base of the treatment tool is inside an image, the human eye continuously tries to focus on the image of the base of the treatment tool. Continued operation in this state causes the viewer to feel increased eyestrain.

Japanese Patent Application Laid-Open No. 2008-136671 discloses a laser probe for a stereoscopic endoscope which provides reduced feeling of disturbance in an image by using a light transparent material in a laser probe, which projects through a treatment tool insertion channel, except for a tip of the laser probe so as to reduce visibility of portions other than the tip.

The laser probe described in Japanese Patent Application Laid-Open No. 2008-136671 reduces feeling of disturbance by using a transparent covering material which reduces visibility of portions other than the tip of the laser probe.

However, the tip of the laser probe is still located in a visible position and therefore provides feeling of disturbance. Further, if the treatment tool having no light transparency is used, such as forceps and wire, reduction of feeling of disturbance is difficult.

### SUMMARY OF THE INVENTION

The present invention provides a stereoscopic endoscope capable of reducing feeling of disturbance by disturbing observation of an area in which images are not fusable.

In accordance with at least one embodiment of the present invention, an endoscope includes a treatment tool; a right eye image capturing unit; and a left eye image capturing unit. The right eye image capturing unit (first image capturing unit) and the left eye image capturing unit (second image capturing unit) capture images which are to be displayed as a stereoscopic image of an image capturing target; and the maximum convergence angle of arbitrary point in movable range of the treatment tool which exists in both visual fields of the right eye image capturing unit and the left eye image capturing unit is 30 degrees or less.

Advantageously, according to the present invention, feeling of disturbance during the use of the endoscope may be reduced by allowing capturing of images only in an area in which images are fusable.

Further features of the present invention will become apparent from the following description of exemplary embodiments with reference to the attached drawings.

### BRIEF DESCRIPTION OF THE DRAWINGS

FIGS. 1A and 1B are schematic diagrams illustrating a configuration of an endoscope according to the present invention.

FIG. 2 is a schematic diagram illustrating an operation of the stereoscopic endoscope according to one embodiment of the present invention.

FIGS. 3A and 3B are schematic diagrams illustrating a relationship between a fusion area and possibility of fusion.

FIGS. 4A and 4B are schematic diagrams illustrating a stereoscopic endoscope system according to one embodiment of the present invention.

FIG. 5 is schematic diagram illustrating a stereoscopic endoscope according to another embodiment of the present invention.

FIG. 6 is schematic diagram illustrating the stereoscopic endoscope according to another embodiment of the present invention.

FIG. 7 is a schematic plan view of a tip of a stereoscopic endoscope.

FIGS. 8A to 8C are schematic diagrams illustrating a stereoscopic endoscope system.

### DESCRIPTION OF THE EMBODIMENTS

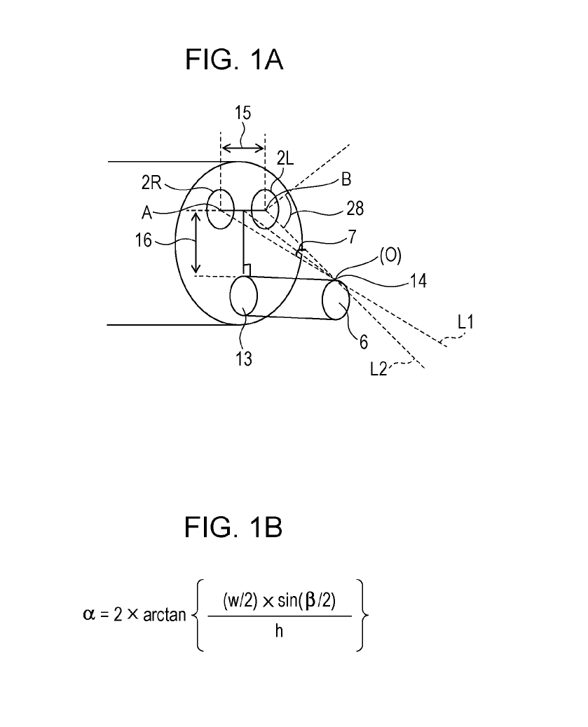

FIG. 1A illustrates a configuration of an endoscope of the present invention, in which a treatment tool 6 projects forward and backward through a port 13 of a treatment tool insertion channel formed at a tip of the endoscope.

The endoscope according to the present invention is provided with the treatment tool 6, a right eye image capturing unit 2R, and a left eye image capturing unit 2L. The endoscope captures an image of an image capturing target by the right eye image capturing unit 2R and the left eye image capturing unit 2L, and the captured image is to be displayed as a stereoscopic image.

Visual fields observable by the right eye image capturing unit and by the left eye image capturing unit are determined on the basis of the characteristics of an optical system of these image capturing units, and the size of a pixel array of an image capturing element.

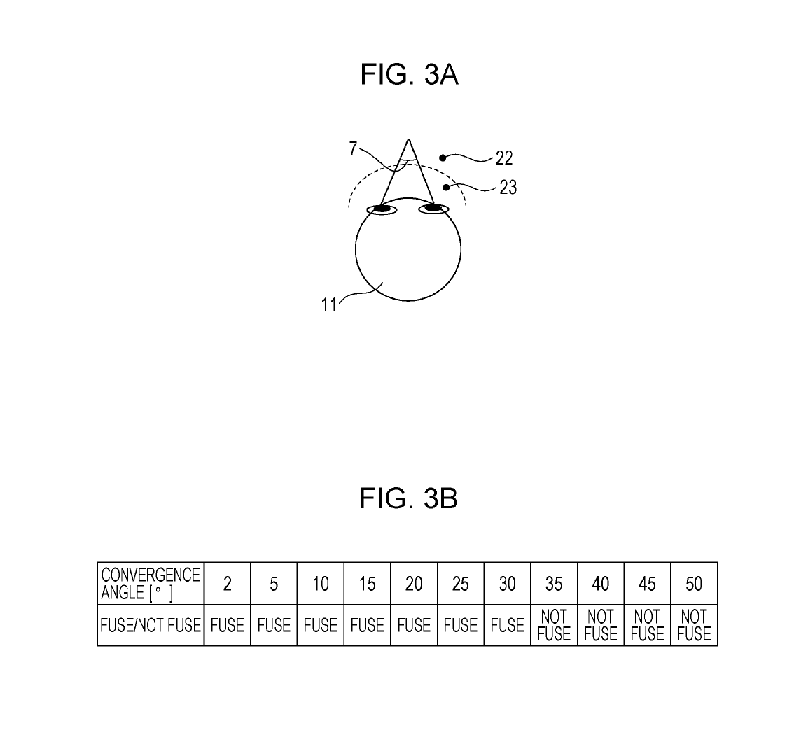

For ease of illustration, the optical system of this endoscope will be described as the following optical system with reference to FIG. 1A: an optical system in which two boundary lines L1 and L2 of the visual fields cross a point O of intersection 14; one of the boundary lines L1 is on a line segment OA extending between the point O of intersection 14 and an image capturing center A of the right eye image capturing unit 2R (first image capturing unit), and the other of the boundary lines L2 is on a line segment OB extending between the point O of intersection 14 and an image capturing center B of the left eye image capturing unit 2L (second image capturing unit). In other words the line segment OA represents a line of sight from the center of the first image capturing unit to an arbitrary point O in a movable range of the treatment tool which exists in the visual field, and the line segment OB represents a line of sight from the center of the second image capturing unit to the arbitrary point O in the movable range of the treatment tool. These two line segments OA and OB define a convergence angle described in detail below. In reality, a light-receiving surface of each image capturing unit has a finite area, the boundary line of the visual fields extends along an end of the light-receiving surface of the image capturing unit as illustrated in FIG. 3A.

The visual field here is an area observable by each image capturing unit. The boundary surface of the visual field here is an interface between the visual field and the non-visual field, i.e., the outermost peripheral surface of the visual field. The boundary line of the visual fields is a straight line located inside the boundary surface of the visual fields.

In the system of FIG. 1A described above, the boundary surface of the visual fields corresponds to a curved surface of a cone defined by a viewing angle 28. More specifically, in FIG. 1A, a point at which the boundary line of the visual fields of the right eye image capturing unit 2R and the boundary line of the visual fields of the left eye image capturing unit 2L cross a movement line of the treatment tool 6 is the point of intersection 14 (i.e., the point of intersection O) in the visual fields of the right eye image capturing unit 2R and the left eye image capturing unit 2L. The convergence angle 7 at which two boundary lines of the visual fields cross at the point of intersection 14 is not greater than 30 degrees.

The movement line is one of movement loci within a movable range of the treatment tool 6. In FIG. 1A, the movement locus of the tip of the treatment tool 6 is the movement line. That is, an angle 7 formed between the line segment OA extending between the point of intersection 14 and the image capturing center A of the right eye image capturing unit and the line segment OB extending between the point of intersection 14 and the image capturing center B of the left eye image capturing unit is not greater than 30 degrees. This angle is the “maximum convergence angle” within the visual field. The point of intersection 14 is located within the visual fields of the image capturing units, and is an arbitrary point at which the convergence angle becomes the maximum within the movable range of the treatment tool.

According to the present invention, the maximum convergence angle of an arbitrary point in a movement line range of the treatment tool located within both the visual fields of the right eye image capturing unit and the left eye image capturing unit is not greater than 30 degrees. With this configuration, it is possible to capture images only in the area in which images are fusable, and thus to reduce feeling of disturbance during the use of the endoscope.

In order to make the maximum convergence angle in a case in which the treatment tool is located in the visual fields of both the image capturing units be not greater than 30 degrees, it is necessary to suitably determine the distance 15 between the centers of the two image capturing units 2R and @L which corresponds to the distance between two objective lenses, the distance 16 between the objective lens and the channel, and the viewing angle 28.

The equation of FIG. 1B is satisfied when the convergence angle 7 is α, the distance 15 between the objective lenses is w, the distance 16 between the objective lens and the channel is h, and the viewing angle 28 is β. The equation of FIG. 1B may not necessarily be satisfied: the center of the treatment tool may be misaligned with a perpendicular line drawn from the two image capturing units and the midpoint of the two image capturing centers. Distance may be measured by any known method.

The convergence angle may be calculated using, for example, the cosine theorem, although there is not restriction thereto and any other mathematical function may be appropriate.

In the foregoing, the viewing angle 28 is uniform in every direction including horizontal and vertical directions. However, the viewing angle 28 may have a different angle in each directions including horizontal and vertical.

A larger viewing angle enables observation in the vicinity of the base of the treatment tool. However, a larger viewing angle often captures images that are not fusable. A smaller viewing angle does not easily capture images that are not fusable, but increases an area in which the treatment tool is not capturable.

It is preferred to design the optical system so that the viewing angle of the image capturing unit used in the present invention is 60 degrees to 100 degrees. This is because too large viewing angle may capture images that are not fusable. A too small viewing angle does not capture images that are not fusable, but a user cannot view the treatment tool unless the treatment tool is projected to a certain length. Therefore, the viewing angle is preferably in the above-described range.

According to an embodiment of the present invention, the following endoscope is provided: a user, who is viewing the image capturing target, operates the treatment tool projected from the endoscope tip; then, every portion in an image is fusable and the user may obtain a stereoscopic display image which does not cause eyestrain.

Exemplary treatment tools used in the present invention include instruments for surgical operations, such as laser probes and forceps. The treatment tool moves linearly from the treatment tool insertion channel, but may be slightly bent by gravity or other force. A range in which the treatment tool is moved outside the port is referred to as a movable range. In the example of FIG. 1A, the treatment tool is moved along the straight line within the movable range.

The treatment tool may be made of a material that is strong enough not to deform by self weight after being projected from the treatment tool insertion channel. The projection length of the treatment tool is not limited as long as the treatment tool does not deform by self weight; and preferably is not shorter than 2 cm to not longer than 5 cm.

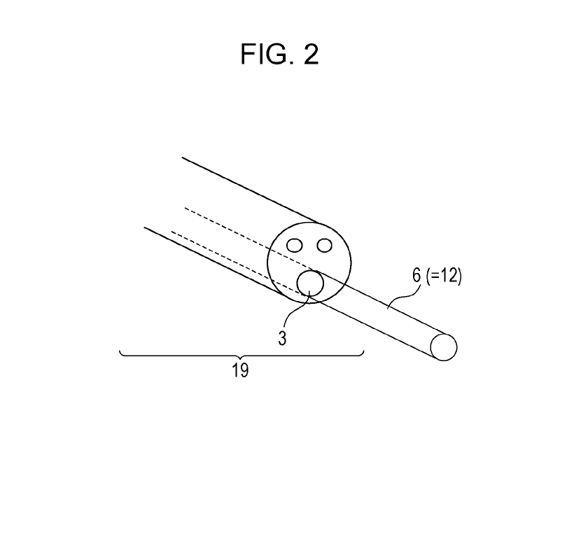

FIG. 2 illustrates a state in which the treatment tool 6 is projected to the maximum length during the use. The projection length of the treatment tool 6 out of the channel 3 is equivalent to the movable range 12 (i.e., the maximum projection length). In a distance in which a user intends to carry out an operation, e.g., about 5 cm, bending of the treatment tool by self weight is very small and thus may be ignorable.

An object, of which image is to be captured by the image capturing unit, is referred to as the “image capturing target”. The right eye image capturing unit and the left eye image capturing unit used in the present invention are image capturing units which capture images for the right and left eyes of an observer. One or multiple right eye image capturing units may be provided and one or multiple left eye image capturing units may be provided. The image capturing unit is not necessarily round, but may be elliptical or rectangular in shape. If multiple image capturing units for either of the eyes are provided, the barycenter of the image capturing units of each image capturing unit is set to the image capturing center A or B, respectively.

An image capturing area of the right eye image capturing unit is typically an area in which the right eye image capturing unit may capture an image. An image capturing area of the left eye image capturing unit is typically an area in which the left eye image capturing unit may capture an image.

A fusion area and a non-fusion area are included in the image capturing area. The fusion area according to the present invention is an area in which an image projected on the retina of the right eye and an image projected on the retina projected on the retina of the left eye may be viewed as a single image. The image capturing target in this fusion area may be fused and may be viewed as a stereoscopic image.

The non-fusion area is an area other than the fusion area in the image capturing area. The image capturing target in this non-fusion area is in double vision and cannot be viewed as a single image. Thus, it is difficult to view the object as a stereoscopic image.

According to one embodiment of the present invention, only the fusion area is captured, whereby feeling of disturbance of the user may be reduced. That is, feeling of disturbance is reduced by excluding the non-fusion area from the visual field.

Fusion of images will be described with reference to FIGS. 3A and 3B. FIG. 3A is a conceptual diagram of a fusion area.

FIG. 3B illustrates a result of an experiment about whether or not fusion occurs. Fusion of images is carried out to obtain a stereoscopic image by fusing a right eye image and a left eye image in the brain.

The convergence angle 7 formed when the viewer 11 views a certain point, a point 22 located in a fusion area, and a point 23 located in an area viewed as a double image are illustrated in FIG. 3A.

The following experiment was carried out on multiple persons: each of the persons is made to view a spotlike material in front of him, and an investigation was carried out as to whether the right and left images in the respective eyes of the viewer are fused to a single image. The result of the experiment is shown in FIG. 3B.

The result shows that fusion often occurs when the convergence angle is not greater than 30 degrees. More specifically, from FIG. 3B, it is shown that the maximum convergence angle in a fusable area is substantially in a range from 2 to 30 degrees, but not greater than 30 degrees. Although some variation may be expected due to varying in ages or environments.

A reason the images are not fused is that muscles of eyeballs are not easily adjust themselves to crossed eyes, in which right and left visual lines extend in different directions in order to view the image capturing target.

Another reason is that, since the image capturing target is viewed differently in the right and left eye images when the object is located very close to the image capturing unit, it is therefore difficult to view the object as an identical object.

Eyestrain may be caused when the viewer tries to fuse the images unintendedly. In addition, continuous existence of images which do not fuse within the visual field causes feeling of disturbance and thus causes eyestrain.

For the above reason, in order not to produce feeling of disturbance or eye strain in the viewer, it is preferred to exclude from the visual field images which do not fuse.

Therefore, when the treatment tool projects forward from the treatment tool insertion channel, the convergence angle formed by a point at which the treatment tool first intersects the boundary surface of the visual fields (i.e., the peak of the outer periphery of the treatment tool), the image capturing center of the right eye image capturing unit and the image capturing center of the left eye image capturing unit may be not greater than 30 degrees. Therefore, fusion of images may be carried out at every portion of the treatment tool located in both the right and left eye images.

The convergence angle at this point is not greater than 30 degrees: this fact means that the angle formed by the treatment tool, the right eye image capturing unit, and the left eye image capturing unit is not greater than 30 degrees at all the positions within the visual fields of the image capturing units.

This is because the convergence angle is the largest at the point at which the movement line of the treatment tool (here, the movement locus of the peak of the treatment tool) and the boundary surface of the visual fields intersect.

A mode in which the maximum convergence angle of the stereoscopic endoscope according to the present embodiment is determined to be not greater than 30 degrees has been described above. In particular, for example, the mode may be a design in which the distance between the right eye image capturing unit and the left eye image capturing unit is shortened, or a design in which the distance between the opening of the treatment tool insertion channel and both the image capturing units is increased.

In the design in which the distance between the opening of the treatment tool insertion channel and the image capturing units is increased, a configuration in which the opening is provided in the side of the endoscope body is desirable from the viewpoint of narrowing the diameter of the endoscope body.

There are two convergence angles: one of which is a convergence angle of an object with respect to the objective lenses of the endoscope; and the other is a convergence angle of the viewer's eyes at the endoscope image displayed on a display.

Since the viewer may view the display at a position at which the stereoscopic image of the image capturing target is viewed in the best way, it is desired that the change in the convergence angle of people's eyes is substantially the same as the change in the convergence angle of the object with respect to the endoscope.

When the optical axes of the multiple objective lenses of the endoscope are oriented inward, i.e., toward the base of the treatment tool, the convergence angle with respect to the base of the treatment tool is reduced when observed on the display.

However, such adjustment in the optical axes of the lenses may cause greater difference in the convergence angle of the view of the image capturing target and in the distant view: this may also cause unfavorable eyestrain.

It is possible to make an arrangement of the optical axes with angular difference which is so large that a close image may be viewed easily in a forced manner. However, that arrangement is not optimum in establishing a system which observes an entire stereoscopic view by the naked eye.

In the present invention, it is desirable that the convergence angle of the viewer's eyes at the display is approximate to the convergence angle of the observation target with respect to the right eye image capturing unit and the left eye image capturing unit of the endoscope.

The stereoscopic endoscope according to the present embodiment may obtain images which are easy to fuse when the maximum convergence angle is set to not greater than 30 degrees. If the viewer still has the feeling of disturbance due to non-fusion of images when the convergence angle is set to not greater than 30 degrees, the feeling of disturbance may be reduced by, for example, image processing.

The image processing may include making the image that causes feeling of disturbance invisible or converting the images into easy-to-fuse images before the fused image is displayed. For example, image processing may be used to delete or block images which are obtained at an angle greater than 30 degrees.

### First Embodiment

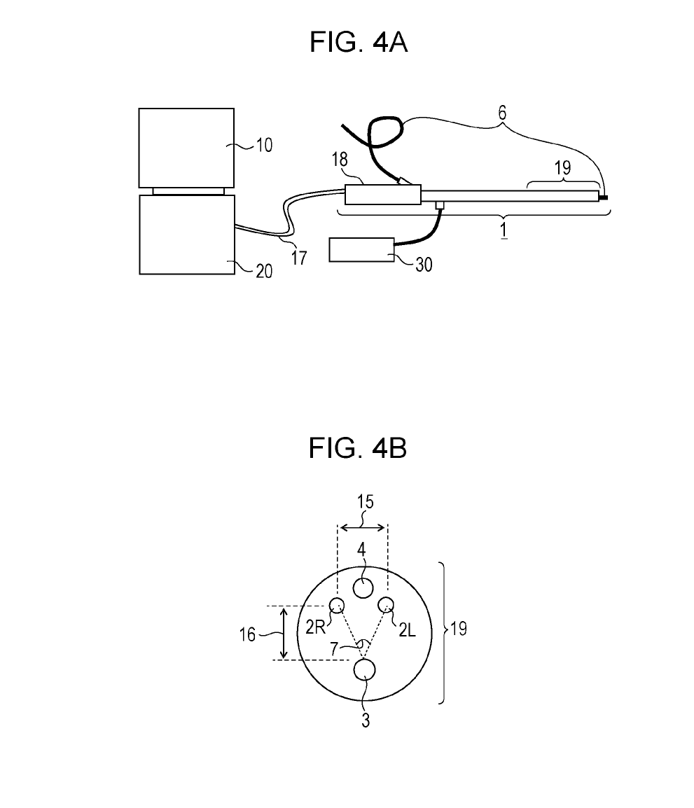

A stereoscopic endoscope system of the present embodiment will be described with reference to FIGS. 4A and 4B. The stereoscopic endoscope system according to the present embodiment is provided with, as main components, a stereoscopic endoscope 1, a stereoscopic display 10, a video processor 20, and an external light source 30.

The stereoscopic endoscope 1 is provided with a manipulation unit 18 which is a handle grasped by a user, and an endoscope tip 19 which is inserted in the body to be observed. The stereoscopic endoscope 1 is capable of capturing two parallax images. The stereoscopic endoscope 1 may be a monocular endoscope which captures two parallax images by different optical paths inside and captures two images with parallax, or may be a pantoscopic endoscope.

An objective lens and an image capturing element at which an optical image which passed the objective lens is imaged are provided at a tip of the endoscope. CCD (charge-coupled device) image sensors and CMOS (complementary metal-oxide semiconductor) image sensors are exemplary image capturing elements.

The image capturing element used in embodiments of the present invention may be provided at the endoscope tip, or may be provided at the manipulation unit of the endoscope. An image capturing element, when provided at the manipulation unit of the endoscope, may include a mechanism to transmit information from the endoscope tip to the manipulation unit of the endoscope using an optical fiber or relay lenses, for example.

FIG. 4B is a front plan view of an endoscope tip 19.

An illumination window 4 illuminates the image capturing target from the endoscope tip by a fiber bundle which is projected from a base of the endoscope and guides light from the external light source 30.

The external light source 30 typically is white light. White light is used in order to observe the color of the target accurately.

Exemplary white light sources include a xenon light source and a halogen light source. The xenon light source is preferred because it has illumination strength that is not varied easily between the long wavelength and the short wavelength.

Image information of an optical image captured at the endoscope tip is transmitted inside the endoscope as electrical signals, and is transmitted to the video processor 20 via a signal cable 17 connected to the endoscope manipulation unit 18.

The video processor 20 is a stereoscopic display processing circuit which transforms the transmitted signals to be displayed as a stereoscopic image on the display 10, which is a display device that outputs images of right and left images, and carries out other image processing.

The stereoscopic display 10 as a display device is connected to the video processor 20 and displays an image as a stereoscopic display in accordance with transmitted video signals for stereoscopic display.

Exemplary stereoscopic displays may include a flat panel display, such as LCD, OLED and plasma display, and a projector. The stereoscopic display is implemented by, for example, circularly polarized light and an active shutter, both of which require dedicated glasses. Among them, the circularly polarized light system is suitable in which lightweight dedicated glasses that do not require synchronization.

A treatment tool 6 is, for example, a laser fiber and forceps, and is provided with a cable having a diameter wide enough to receive a treatment tool insertion channel 3 inserted therein. The treatment tool insertion channel 3 has a space in which the treatment tool is inserted.

The treatment tool 6 is made of a flexible material which bends together with the bending of the treatment tool insertion channel.

The present embodiment will be described with reference to a configuration in which the center of the treatment tool is aligned with a perpendicular line drawn from the two image capturing units and the midpoint of the two image capturing centers. However, the present invention is not limited to this configuration.

The treatment tool of the stereoscopic endoscope of the present embodiment is located at the same distance from both the image capturing units and therefore has improved operability.

Here, a point at which the boundary line of the visual fields of the right eye image capturing unit and the boundary line of the visual fields of the left eye image capturing unit cross a movement line of the treatment tool is the point of intersection O in the visual fields of the right eye image capturing unit and the left eye image capturing unit. The angle formed between a line segment OA extending between the point of intersection O and an image capturing center A of the right eye image capturing unit and the line segment OB extending between the point of intersection O and an image capturing center B of the left eye image capturing unit is not greater than 30 degrees, and more preferably, not greater than 25 degrees.

Here, an angle θ formed between a line segment extending between the peak of a port 13 and the image capturing center of the right eye image capturing unit and a line segment extending between the peak of the port 13 and the image capturing center B of the left eye image capturing unit is set to 0.25 degrees (tan θ=0.25).

In this configuration, all the objects viewed by the viewer on the display is parallax images in the fusion area, and therefore eyestrain is reduced.

In particular, the diameter of the endoscope is 12 mm, the distance 15 between the objective lenses is 3 mm, the distance 16 between the objective lens and the channel is 6 mm, and the radius of the treatment tool insertion channel is 1 mm.

The viewing angle of the angle lens is 90 degrees which is the maximum degree. In this case, the maximum value of the convergence angle at an arbitrary point of the treatment tool, i.e., the maximum convergence angle, is 20.0 degrees, which is not greater than 30 degrees.

The maximum convergence angle of the invention disclosed in Japanese Patent Application Laid-Open No. 2008-136671 is estimated, in a similar manner, to be 68 degrees.

This angle is far greater than 30 degrees and thus it is difficult to fuse the right and left images.

This is supported by the fact that unfused image is illustrated in FIG. 10 of Japanese Patent Application Laid-Open No. 2008-136671.

In the estimation of the convergence angle of the endoscope disclosed in Japanese Patent Application Laid-Open No. 2008-136671, the distance between the image capturing units is set to 10 mm, and the distance between the channel and the image capturing unit is set to 6 mm.

The convergence angle according to the present embodiment is calculated using the equation of FIG. 1B.

In the present embodiment, the convergence angle is calculated on the assumption that there is no direction dependency of the viewing angle of the optical system.

The convergence angle of the stereoscopic endoscope according to the present embodiment is determined on the basis of the viewing angle of the image capturing unit, the length between the image capturing units, and the distance between the image capturing unit and the opening of the treatment tool insertion channel.

### Second Embodiment

An endoscope according to a second embodiment is the same as the endoscope according to a first embodiment except that a tip surface of the endoscope is inclined at 21 degrees.

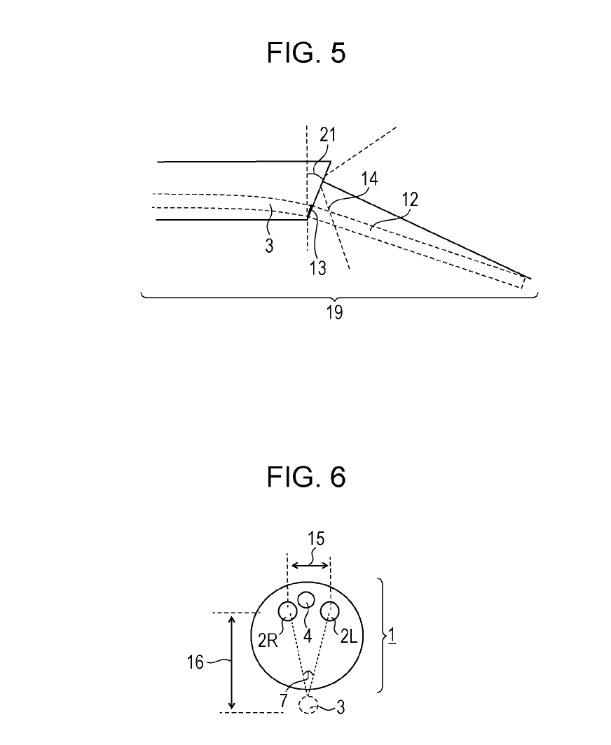

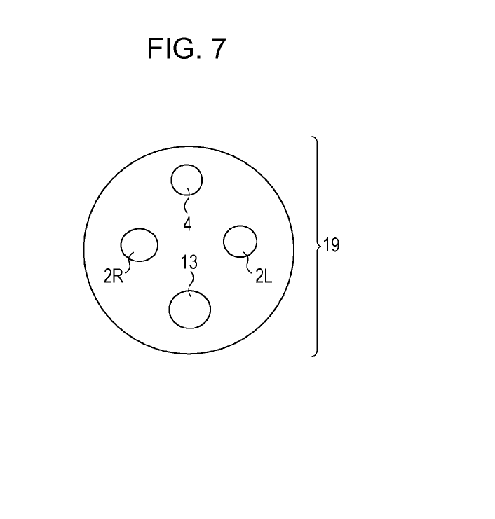

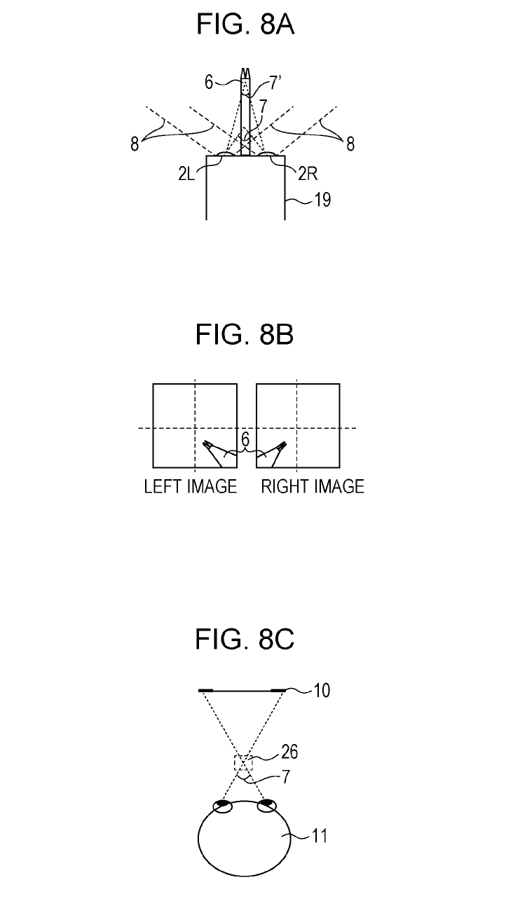

As illustrated in FIG. 5, a port 13 of a treatment tool insertion channel 3 is provided at a sloped tip surface. FIG. 5 illustrates a state in which the treatment tool has extended to the maximum length thereof. In this state, a point 14 in a movable range 12 (i.e., a locus of the treatment tool) is an arbitrary point on the locus of the treatment tool, and is the position at which the convergence angle becomes the maximum within the visual field.

The focal length is 50 mm at the center of the objective lens, and the angle of deviation is 30 degrees.

In this case, the convergence angle becomes the maximum at the position 14 in the movable range of the treatment tool by setting the angle of a port of the treatment tool insertion channel to 23 degrees with respect to the vertical direction. The maximum convergence angle is not greater than 30 degrees.

An image capturing target projected at the center of the image may be treated at a focal position. This configuration provides improved operability without producing eyestrain.

The optical axis of the lens is the center line in the visual field of the lens, which is illustrated by the solid line in FIG. 5. A focused area exists on the optical axis as a spot or a line segment. Images are clear when viewed even with a single eye in the focused area. Therefore, if the treatment tool is located at an intermediate position of the right and left focused areas on the optical axis of the lens and an operation is carried out at that place, the user may carry out an operation while viewing a clear image at the center of the image.

As described above, the endoscope according to the present embodiment reduces eyestrain and positions the location at which an operation is carried out at the center of the image. This configuration improves operability and easier observation of the state around the location at which the operation is carried out.

### Third Embodiment

The endoscope of a third embodiment is the same as the foregoing embodiments except for the configuration of an endoscope tip.

As illustrated in FIG. 6, the diameter of the endoscope is 8 mm, the distance 15 between objective lenses is 4 mm, and the distance 16 between the objective lens and the channel 3 is 10 mm. The angle of deviation of a tip surface is set to 30 degrees. A port which is an opening of the treatment tool insertion channel is provided on a side of the endoscope tip. The angle at which the treatment tool extends is 23 degrees with respect to the horizontal plane. The viewing angle of each image capturing unit is 90 degrees.

In this case, in the movable range of the treatment tool, the convergence angle at the position at which the convergence angle is the maximum is 18 degrees, i.e., not greater than 30 degrees. In this configuration, the image to be displayed is a fused image and, therefore, eyestrain is reduced.

In the first and second embodiments, the port 13 of the treatment tool insertion channel is disposed on the same plane as that of the objective lens surface. In the third embodiment, the port 13 of the treatment tool insertion channel is located on the side of the endoscope. In this configuration, the treatment tool may be disposed at a position further away from the image capturing unit as compared with those of the first and second embodiments.

Therefore, the maximum convergence angle of the treatment tool may be further reduced. This corresponds to the increase in the parameter h in the equation of FIG. 1B. The endoscope according to the present embodiment is advantageous as compared with the first and second embodiments which have the image capturing units and the opening of the treatment tool insertion channel on the same face. That is, the endoscope of the present embodiment has the opening of the treatment tool insertion channel and the image capturing units disposed at different positions of the endoscope body, and thus the distal end of the endoscope may have a reduced diameter.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-117136 filed May 25, 2011, which is hereby incorporated by reference herein in its entirety.

What is claimed is:

1. An endoscope comprising:
a treatment tool;
a right eye image capturing unit; and
a left eye image capturing unit,
wherein:
the right eye image capturing unit and the left eye image capturing unit capture images which are to be displayed as a stereoscopic image of an image capturing target; and
the maximum convergence angle of arbitrary point in movable range of the treatment tool which exists in both visual fields of the right eye image capturing unit and the left eye image capturing unit is 30 degrees or less.

2. The endoscope according to claim 1 wherein a port of the treatment tool is located on the side of the stereoscopic endoscope.

3. A stereoscopic endoscope system comprising:
the endoscope according to claim 1;
a stereoscopic display processing circuit which carries out a stereoscopic display process on an image captured by a right eye image capturing unit and an image captured by a left eye image capturing unit; and
a display device which displays an image output from the stereoscopic display processing circuit.

4. An endoscope comprising:
a first image capturing unit;
a second image capturing unit; and
a movable treatment tool,
wherein the first image capturing unit and the second image capturing unit are configured to collectively capture at least two parallax images of an image capturing target located within a visual field,
wherein a first line of sight from the center of the first image capturing unit to an arbitrary point in a movable range of the treatment tool which exists in the visual field and a second line of sight from the center of the second image capturing unit to the arbitrary point in the movable range of the treatment tool define a convergence angle equal to or less than 30 degrees, and
wherein, when the parallax images are captured in the visual field equal to the convergence angle, the parallax images are fused and displayed as a stereoscopic image.
